(19) United States
(12) Patent Application Publication
(10) Pub. No.: US 2008/0026689 A1
(43) Pub. Date: Jan. 31, 2008

(54) System for simultaneously communicating and jamming other RF signals

(76) Inventors: Paul Johnson, El Cajon, CA (US); William Shepherd, San Diego, CA (US); Ky-Hien Do, Kihei, HI (US)

Correspondence Address: TREX ENTERPRISES CORP., 10455 PACIFIC COURT, SAN DIEGO, CA, 92121, US

(21) Appl. No.: 11/881,532

(22) Filed: Jul. 27, 2007

Related U.S. Application Data
(63) Continuation-in-part of application No. 11/603,582, filed on Nov. 22, 2006.
(60) Provisional application No. 60/833,967, filed on Jul. 27, 2006.

(51) Int. Cl. H04K 3/00

(52) U.S. Cl. 455/1

(57) ABSTRACT

A radio radio quasi-circulator-jammer system, which connects a transceiver and a jammer unit to a single antenna, for isolating the transceiver from the co-located transmitter jammer. The radio quasi-circulator-jammer system includes includes a quasi-circulator having a transformer, a matched electrical load having an electrical impedance substantially matched to the antenna electrical impedance and three radio signal splitters adapted to split incoming radio power signals into two substantially equal outgoing radio power signals. The three radio signal splitters and said transformer are arranged produce: a circulation within the quasi-circulator of about one-half of output power of the jammer transmitter and the communication transmitter in a first direction and a circulation of about one-half of said output power of the jammer transmitter and the communication transmitter in a second direction opposite said first direction and a circulation within said quasi-circulator of about one-half of input power received by said antenna in said first direction and a circulation of one-half of said input power received by said antenna said second direction; with the transformer positioned within said quasi-circulator so that substantially all output power of the two transmitters that is not otherwise transmitted or dissipated is cancelled in said transformer.

### CROSS REFERENCE TO RELATED APPLICATIONS

This invention is a continuation-in-part of U.S. patent application Ser. No. 11/603,582 filed Nov. 22, 2006 which is hereby incorporated herein by reference. This invention also claims the benefit of Provisional Patent Application Ser. No. 60/833,967 filed Jul. 27, 2006.

### FIELD OF INVENTION

This invention relates to radio systems and in particular to radio jamming systems.

### BACKGROUND OF THE INVENTION

### Radio Jammers

In some radio jamming applications a wide bandwidth radio noise signal is transmitted at a high power level, which prevents the reception of communication signals by overwhelming the communications signal(s) at the receiver. It is often desirable to maintain ones own communications through the jamming signal, while simultaneously jamming others, even in the same general frequency bands. If the jamming signal source is close to one's own communications receiver, this task can be very difficult. In some cases, the jamming signal source is co-located with a communications receiver that the user does not want jammed, as in the case of a military vehicle on patrol, or sited at a remote location.

Collocation of antennas can cause a received communication signal to be degraded by the transmit energy of a neighboring jammer. This degradation can result in a significant reduction in the communication range or data rate of the radios. The interference can sometimes be mitigated by separating the antennas by enough space to increase the free space losses of transmit power between the associated antennas, or to operate communications at frequencies not used by the jamming transmitter. At many frequencies the distance necessary to accomplish the required isolation is not feasible and the crosstalk interference can greatly diminish the performance. It is also often desirable to jam communications of others operating in essentially the same frequency bands as one's own communications, making isolation by frequency difficult.

### Improvised Explosive Devices

Improvised explosive devices (IED's) have been the single largest threat to United States and allied forces in the Iraq war, amassing over 11,000 cumulative casualties in 2004. IED detonation signals are typically broadcast from low cost commercial and household transmitters, such as garage door openers, car alarms, wireless phones, and remote controlled toys. These device operate at various frequencies from 27 MHz up to 5800 MHz. IED jammers broadcast a high power signal over the frequency range of interest that desensitizes the IED receiver, disrupting the receipt and decoding of the detonation signal.

Significant strides have been made to thwart radio frequency remote control initiated IED's with the deployment of jamming transmitters. The success of current generation IED jammers comes at a price, however—the jammers also produce noise in bands and frequencies that our armed forces rely upon for friendly and tactical communication. Present broadband jamming devices, used on vehicles to defeat Remote Control IED's, interfere with other desired communications equipment near the jammer. Broadband jammers require significant RF radiated power to address threats across significant frequency and spatial domains.

What is needed is a system that can successfully jam RCIED trigger signals while allowing friendly communications to proceed.

### SUMMARY OF THE INVENTION

The present invention provides radio radio quasi-circulator-jammer system, which connects a transceiver and a jammer unit to a single antenna, for isolating the transceiver from the co-located transmitter jammer. The radio quasi-circulator-jammer system includes includes a quasi-circulator having a transformer, a matched electrical load having an electrical impedance substantially matched to the antenna electrical impedance and three radio signal splitters adapted to split incoming radio power signals into two substantially equal outgoing radio power signals. The three radio signal splitters and said transformer are arranged produce: a circulation within the quasi-circulator of about one-half of output power of the jammer transmitter and the communication transmitter in a first direction and a circulation of about one-half of said output power of the jammer transmitter and the communication transmitter in a second direction opposite said first direction and a circulation within said quasi-circulator of about one-half of input power received by said antenna in said first direction and a circulation of one-half of said input power received by said antenna said second direction; with the transformer positioned within said quasi-circulator so that substantially all output power of the two transmitters that is not otherwise transmitted or dissipated is cancelled in said transformer. The system also includes a communication receiver for receiving remote radio power signals at an output of said secondary coil of the transformer. Since the jamming signal is cancelled in the transformer the remote radio power signals received by said receiver are significantly greater than the jamming radio transmission transmitted by jammer transmitter.

The system can jam threat signals efficiently, with its own emissions closely tuned to the threat frequency. The invention provides a jamming system that is small, low power, protects friendly communications, and can provide valuable signal information for exploitation. The quasi-circulator serves as the core enabler for allowing an RCIED jammer to suppress detonation trigger signals, while not severely desensitizing an adjacent communication receiver. The system can effectively reduce coupling between the jamming transmitter and the communications transceiver caused by co-sited antennas operating at like or neighboring frequency bands. In operation, the Isolator divides the transmitted jammer energy between the antenna radiating surface and an electrically symmetrical path. The two substantially equal energies are recombined in a 180-degree element such as a Balun transformer ahead of presentation to the communications transceiver. Essentially, the transmitted jammer signal is combined with its inverse (canceling its effect) at the input to the communications receiver, but the communications signal from the antenna passes directly (with some loss) to the transceiver. This can produce 45 or more dB of isolation at the communications receiver between the jammer output and the antenna (received) communications signal.

### BRIEF DESCRIPTION OF THE DRAWING

FIG. 1 is a drawing of a preferred embodiment.

### DETAILED DESCRIPTION OF PREFERRED EMBODIMENTS

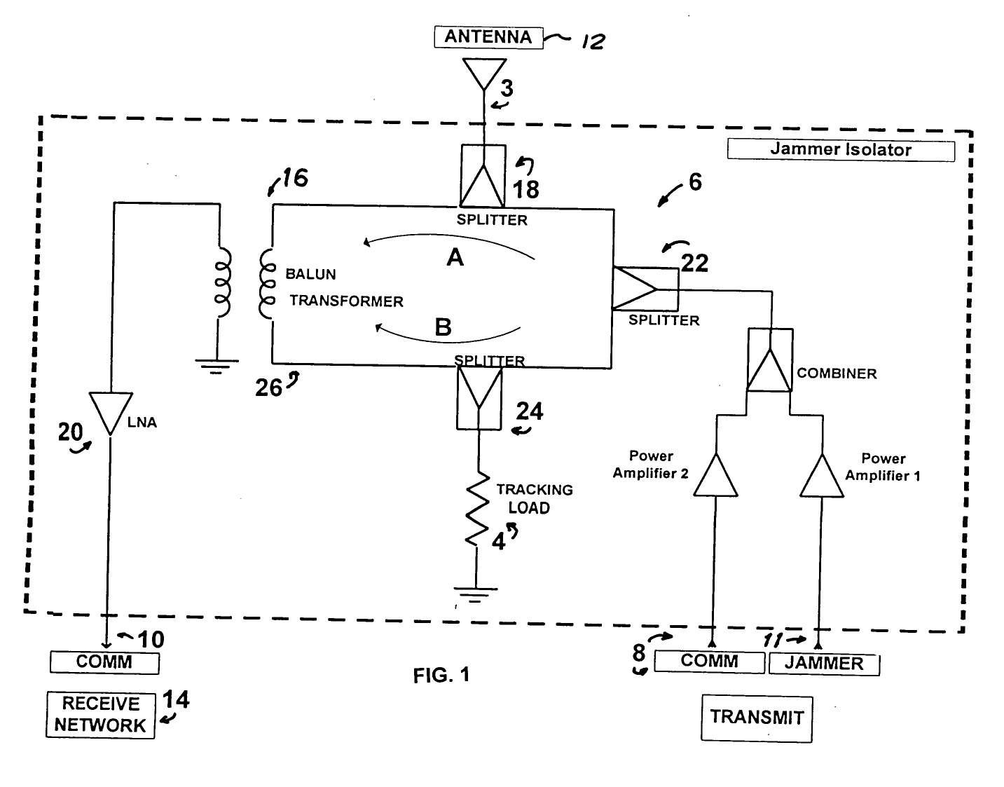

A preferred embodiment of the present invention is shown in FIG. 1. This drawing is a schematic diagram of system proposed for co-site interference mitigation of remote controlled improvised explosive devices. In this case, a single communications receiver is coupled with a communications transmitter and a jamming transmitter. With reference to FIG. 1, the transmit path combines both the communication transmitter and the jamming transmitter together (note that the output ports are isolated via the signal combiner) towards the antenna via the path labeled “A.” Applicants refer to this system as a “radio quasi-circulator-jammer”. The presence of the transformer in the receive path creates two jamming signals of equal amplitude, with one signal being the inverse of the other, thus canceling the transmit signal at the path labeled “B.” Thus, the receiver is isolated from the transmitted jamming signal, allowing simultaneous operation of the communication link and IED jamming. The degree of cancellation depends on the phase and amplitude matching of the components in the system, as well as the matching between the antenna tracking (dummy) load and the actual antenna. Other signals received from the antenna do not appear with equal amplitude at each side of the transformer (very unequal, in fact), so are relatively unaffected as they pass through it.

A key design element of the radio quasi-circulator-jammer is balancing of phase and amplitude throughout the system. Additionally, a synthesized ‘tracking’ load approximating the load of the antenna is provided to optimize isolation. FIG. 1 shows a block diagram of the isolator system 2. In this case, the antenna ‘tracking load’ 4 is approximated with a 50-ohm resistor.

Transmit and receive paths of the communications transceiver are divided near the transceiver by means of a circulator, switch, power divider, or similar method, which is not shown in the figure. It is assumed that the communication transceiver already has separate transmit and receive paths. The radio quasi-circulator-jammer has four ports (not counting the antenna ‘tracking load’) consisting of a connection 6 to the antenna(s), a connection 8 to the transmit path of the communications transceiver, a connection 10 to the receive path of the transceiver, and a connection 11 to the transmit path of the jammer.

The transmit energy from the transmitters is divided equally between the radiating antenna 12 and the synthesized antenna ‘tracking load’ 4. Some small amount of energy that is reflected from antenna 12 and from the ‘tracking load’, and some energy coupled by the third port of the power divider continues toward the receive network 14 of the transceiver. The substantially equal energy is combined in a Balun transformer 16 (or similar coupling device) with one port 180 degrees out of phase with the other. The differential ports of the Balun transformer thus cancel the energy from the two similar paths and connect the single ended port (the antenna) to the receive network. Thus, depending on phase and amplitude matching of the two networks, much of the transmit energy (from either the communication or the jammer transmitter) is canceled before entering the receive network, yet receive and transmit networks are connected to the same antenna. An additional benefit of the system is that return loss from antenna mismatch, and any noise or harmonics introduced by amplifiers’ in the transmit network can be canceled or reduced before entering the receive network.

The energy received by the antenna 12 is likewise split between two networks, but the paths of these networks are not symmetrical. One half of the energy goes through a splitter 18, Balun transformer 16, and low-noise amplifier 20 into ‘the communications receiver. The other half of the energy travels through two additional power dividers 22 and 24 before entering the 180-degree negative port 26 of the Balun transformer 16. The port isolation of these dividers causes the received (from the antenna) signal energy to be reduced by 50-60 dB by the time it enters the 180-degree port 26 of the Balun. Since the received signal entering the top of the Balun (0-degree phase input) is greatly out of amplitude balance with that entering the bottom of the Balun (180-degree phase input), there is little or no cancellation by the transformer of the signal energy received at the positive port 28 of transformer 16 from antenna 12.

In this embodiment of the invention, a single communication transceiver is connected to a single antenna and a single jammer transmitter. Other embodiments allow for multiple communications transceivers, receivers, transmitters, jammers, and antennas to be employed.

In this embodiment of the invention, all power splitters are assumed to be 3 dB, and so the power received at the antenna is reduced by 3 dB before entering the communications receiver. This essentially increases the noise figure of the receiver by 3 dB. In addition, transmitted power from the jammer or the communication transmitter is reduced by 6 dB before it is presented to the antenna. These disadvantages, which may affect communications link margin by 9 dB, are more than made up for by the reduction in interference that would otherwise occur between communication transceivers or a jammer and communication receiver that are co-located. Other embodiments allow for a trade-off between loss from the antenna to the receiver, and loss from the transmitter to the antenna.

Applicants have developed and tested a laboratory prototype isolator circuit that allows multiple radios (or a jammer and radios) to be connected to a single antenna, with an improvement in performance over separate co-located antennas, if more than one radio is operational (or if a jammer is operational). Interference from adjacent radios is actually reduced by using this isolator circuit and a single antenna, in comparison with multiple, separate, and relatively closely spaced antennas. Some degradation in performance is experienced if a single radio is operated through the isolator circuit when no interfering signals are present. That system was designed to couple 4 radios, operating over the 20-100 MHz band, into a single antenna, and mitigate co-site interference between the radios.

When one of the radios attached to the isolator circuit is a jammer transmitter, interference from the jammer to the other radios attached to the isolator will be reduced by approximately 50 dB. That level of signal isolation will be enough to allow communications to take place while simultaneously jamming the communications, or IED trigger signals, to and from other RF devices nearby (and not connected to the device). Onboard jammers with output power sufficient to jam receivers out to 300 yards should be isolatable in this arrangement.

When using the isolator circuit, sensitivity of the communications receiver is reduced by approximately 3 dB, and transmitted power by approximately 6-9 dB. These reductions are much less than the desensitization of a communications receiver caused by an adjacent transmitter operating in the same frequency band. Coupling of multiple radios to a single antenna incurs slightly higher losses ahead of the receiver(s) (6 dB for four radios, 9 dB for 8 radios, etc.). A trade-off between transmitter power loss and received signal loss can be made.

Operational frequency range of the laboratory prototype isolator is from approximately 20 to 100 MHz and is limited by the high power splitter/combiner circuits chosen for the prototype. The device is packaged in a standard 19″ rack-mountable enclosure. This unit could be quickly configured for field-testing, to allow two radios (or a jammer and a radio) to connect to a single antenna, operating up to 450 MHz or to 2500 MHz, depending on the design changes made to the circulator components.

Upgrade and modification of the existing circulator design to extend or change its frequency of operation requires replacement of internal splitter and transformer components, which must be precisely phase and amplitude matched to appropriately cancel unwanted signals. This matching entails some difficulty and tuning during fabrication and could prove to be a limiting factor for the useful frequency range of the device. In addition, the incorporation of an antenna simulator circuit (or dummy load) closely matched to the actual antenna is required. This antenna simulator circuit must be designed to precisely model the antenna employed in the system, in its operating environment. Alternatively, it may be possible to develop a circuit that automatically tunes the antenna dummy load to the same impedance (across the spectrum) seen by the actual antenna in its environment.

Further benefits are realized because the same antenna can be utilized for the communication link and the IED jammer, minimizing the visual appearance of the antenna array. The visual signature of multiple antennas on vehicles has proven to be an effective indicator of command and control units, VIP's or other special use. A reduction in this visual signal may be an important security aspect of future tactical operations

While the present invention has been described in terms of preferred embodiments, persons skilled in the art will recognize that many changes could be made without departing from the scope of the invention. For example, two radio signal amplifiers could be used for amplifying radio signals at two inputs to the primary side of the transformer. A radio signal amplifier could be positioned to amplify output signals from said secondary side of said transformer. A good choice for the three radio signal splitters is Wilkinson dividers. Applicants like the Wilkinson three-port divider with each port having a 50-Ohm characteristic impedance and each divider having a port connected to two other ports with a quarter-wave transmission line transformer of about 70.7 Ohm characteristic impedance, wherein the other two ports are separated by an isolation resister with an impedance of about 100 Ohms. A good choice would be to ground one of two secondary terminals of the transformer. Multiple transceivers could be connected to a single transmitter.

What is claimed is:

1. A radio quasi-circulator-jammer system, with a transceiver and a jammer unit connected to a single antenna, said system comprising:
A) at least one communication transmitter for transmitting a communication transmission,
B) a jammer transmitter for transmitting a jamming radio transmission,
C) a single antenna, defining an antenna electrical impedance within said radio frequency range,
D) a quasi-circulator comprising:
1) a matched electrical load having an electrical impedance substantially matched to said antenna electrical impedance,
2) three radio signal splitters adapted to split incoming radio power signals into two substantially equal outgoing radio power signals, and
3) a transformer defining a primary and a secondary coil, wherein the three radio signal splitters and said transformer are arranged produce:
(i) a circulation within said quasi-circulator of about one-half of output power of said co-located transmitter in a first direction and a circulation of about one-half of said output power of said co-located transmitter in a second direction opposite said first direction and
(ii) a circulation within said quasi-circulator of about one-half of input power received by said antenna in said first direction and a circulation of one-half of said input power received by said antenna said second direction;
with said transformer positioned within said quasi-circulator so that substantially all output power of said transmitter that is not otherwise transmitted or dissipated is cancelled in said transformer, and
E) at least one receiver adapted to receive remote radio power signals at a output of said secondary coil of said transformer, wherein said remote radio power signals received by said receiver is significantly greater jamming jamming radio transmission transmitted by said jammer transmitter.

2. The radio quasi-circulator-jammer system as in claim 1 wherein said quasi-circulator also comprises two radio signal amplifiers for amplifying radio signals at two inputs to the primary side of said transformer.

3. The radio quasi-circulator jammer system as in claim 1 and further comprising a radio signal amplifier positioned to amplify output signals from said secondary side of said transformer.

4. The radio quasi-circulator-jammer system as in claim 1 wherein said three radio signal splitters are Wilkinson dividers.

5. The radio quasi-circulator-jammer system as in claim 4 wherein each of said Wilkinson dividers is a three-port divider with each port having a 50-Ohm characteristic impedance and each divider having a port connected to two other ports with a quarter-wave transmission line transformer of about 70.7 Ohm characteristic impedance, wherein the other two ports are separated by an isolation resister with an impedance of about 100 Ohms.

6. The radio quasi-circulator-jammer system as in claim 1 wherein said transformer is a balun transformer.

7. The radio quasi-circulator-jammer system as in claim 6 wherein one of two secondary terminals of said transformer is grounded.

8. The radio quasi-circulator-jammer system wherein multiple transceivers are connected to a single transmitter.
